(19) United States
(12) Patent Application Publication
(10) Pub. No.: US 2026/0119347 A1
(43) Pub. Date: Apr. 30, 2026

(54) SYSTEM AND METHOD FOR PROVIDING PORT RESILIENCY AND ARTIFICIAL INTELLIGENCE (AI) RECOMMENDATIONS FOR FAILED PORTS AT AN INFORMATION HANDLING SYSTEM

(71) Applicant: Dell Products LP, Round Rock, TX (US)

(72) Inventors: Balasingh Ponraj Samuel, Round Rock, TX (US); Daniel L. Hamlin, Round Rock, TX (US); Srikanth Kondapi, Austin, TX (US)

(73) Assignee: Dell Products LP, Round Rock, TX (US)

(21) Appl. No.: 18/930,325

(22) Filed: Oct. 29, 2024

(51) Int. Cl. G06F 11/20

(52) U.S. Cl. CPC G06F 11/2007; G06F 2201/805

(57) ABSTRACT

A system and method comprising a hardware processor to execute computer-readable program code instructions of a diagnostic subagent to detect damage to a first port at the information handling system via port testing and generate diagnostic port data describing the first port that is damaged among a plurality of ports at the information handling system and execute a port identification and guidance module to gather baseline port mapping data describing mapping of hardware components including the ports within the information handling system and capabilities of those hardware components and the plurality of ports. Execute the port identification and guidance module to input the diagnostic port data and baseline port mapping data into a baseline mapping-to-text machine learning (ML) to generate user-guided text, audio, or image describing which port to use in lieu of the first port that is damaged.

### FIELD OF THE DISCLOSURE

The present disclosure generally relates to execution of computer-readable program code instructions for one or more artificial intelligence (AI) productivity tools. The present disclosure more specifically relates systems and methods of providing port resiliency and AI recommendations via an AI productivity tool for failed ports at the information handling system.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more workspace productivity applications such as for teleconferencing, word processing, sales systems, business software, gaming applications, or the like.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system that includes computer-readable program code instructions of an AI productivity tool operating to provide port resiliency and AI recommendations for failed ports at the information handling system according to an embodiment of the present disclosure;

FIG. 2 is a graphic and block illustrating an information handling system that includes computer-readable program code instructions of an AI productivity tool operating coordinated to provide port resiliency and AI recommendations for failed ports at the information handling system according to another embodiment of the present disclosure; and

FIG. 3 is a flow diagram showing a method of executing computer-readable program code instructions of a port identification and guidance module providing port resiliency and AI recommendations for failed ports at the information handling system according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Artificial intelligence (AI) is a developing technology that is used to increase the efficiency of computing systems and humans alike. The information handling system of embodiments of the present disclosure may include AI productivity tools that interface with various AI productivity tool-enablable software applications that increase the efficiency of the operation of the information handling system. An example of AI technologies includes, but is not limited to, computer-readable program code instructions of an AI productivity tool such as for chat-enabled environments (voice, text, etc.). Often, these chat-enabled environments are described as AI productivity tool modules that receive this voice or text input from a user and implement a number of actions or responses based on the natural language of the input. In some information handling systems, AI productivity tool modules may interface with computer-readable program code instructions of various AI productivity tool-enablable software applications being executed or executable on the information handling system in embodiments herein. These AI productivity tool-enablable software applications may integrate with the AI productivity tools to allow user queries to trigger certain capability intent actions declared, supported, and managed or conducted by these AI productivity tool-enablable software applications to provide responsive hardware or software operations in services, or a generate responses to the user input query.

The AI productivity tool modules described herein may also be used to determine operating characteristics of various hardware devices of the information handling system. For example, the AI productivity tool modules may be used to determine the operating characteristics of ports used to operatively couple the information handling system to various peripheral devices or a power source. An example of such ports may include Universal Serial Bus type C ports (USB-C). USB-C ports may provide a primary interface for external access to modern information handling systems to provide power or input/output (I/O) data via any of a number of peripheral devices or other hardware devices. USB-C ports, however, are susceptible to failures which may have resulted from uneven or misapplied pressure when inserting a USB-C cable into the USB-C port. Indeed, damage may result especially in those situations where the USB-C port is used to couple a USB-C cable to the information handling system multiple times. An information handling system, in order to provide flexibility in peripheral device use, may include multiple USB-C ports. The AI productivity tools described herein may generate text, audio, or invoke images to present to a user via a recommendation and guidance graphical user interface (GUI) to provide recommendations, as needed, that determines whether one or more of the ports have been damaged and direct the user to use another port instead. For example, generated guidance may direct a user as from a first, now damaged, USB-C port that has been detected from diagnostic port data to a second undamaged USB-C port. Still further, the AI productivity tools described herein may also provide the user with purchasing options that may recommend other hardware that could be operatively coupled to the undamaged port, and which may expand the number of available ports (e.g., a docking station). Based on the age and condition of the information handling system, the AI productivity tools described herein may also recommend to the user to purchase a new information handling system in some embodiments.

The present specification, therefore, describes a system executing computer-readable program code instructions of a port identification and guidance module to diagnose and generate port resiliency and artificial intelligence (AI) recommendations for failed ports at the information handling system. The information handling system may include a hardware processing device, a data storage device, and a power management unit (PMU) to provide power to the hardware processing device and data storage device. In an embodiment, the hardware processor may execute computer-readable program code instructions of a diagnostic subagent to detect damage to a port at the information handling system, via testing data sent through the ports or power testing of the ports, and generate diagnostic port data describing a first port that is damaged among a plurality of ports at the information handling system. For example, internal loopback testing or other testing data throughput tests may be conducted to generate diagnostic ort data for each of one or more ports. Power testing at the port may be texted via a power management unit (PMU) detecting a coupling to the port and assessing received power. Additionally, the hardware processor may execute computer-readable program code of a port identification and guidance module to gather baseline port mapping data describing mapping of port hardware within the information handling system and capabilities of that hardware. The hardware processor may then execute computer-readable program code instructions of an AI productivity tool software module to receive the diagnostic port data and baseline port mapping data and provide, as input, the diagnostic port data and baseline port mapping data to a baseline mapping-to-text machine learning (ML) to create user-guided text describing which port to use in lieu of the first port that is damaged or provide and modify an image showing the port location data and recommendations. In some embodiments, the hardware processor may also execute the computer-readable program code instructions of a purchase recommendation module to create a purchase order based on the baseline port mapping data including usage of ports and peripheral device systems to identify purchasable hardware that can be used as a substitute to the first port that is damaged.

In an embodiment, user-query input may trigger the AI productivity tools to identify a failed port. For example, the hardware processor may execute the computer-readable program code instructions of the AI productivity tool software module to receive user-query input associated with operation of the first port that is damaged or a peripheral device operably coupled thereto and direct an AI productivity tool plugin to invoke a plurality of ML model algorithms to identify a plurality of responsive capabilities or large language model (LLM) generated text recommendation processes associated with the built-in AI productivity tool-enablable software applications and the plug-in AI productivity tool-enablable software applications that semantically or lexically match as responsive to the user-query input. This user-query input may be a result of the user detecting that a peripheral device coupled to the port is not working correctly and the user requests that the issue be fixed at the AI productivity tool software module described herein. In an embodiment, the responsive capabilities identified or LLM generated text recommendation processes by the AI productivity tool plugin may include an internal loopback testing capability associated with a port driver.

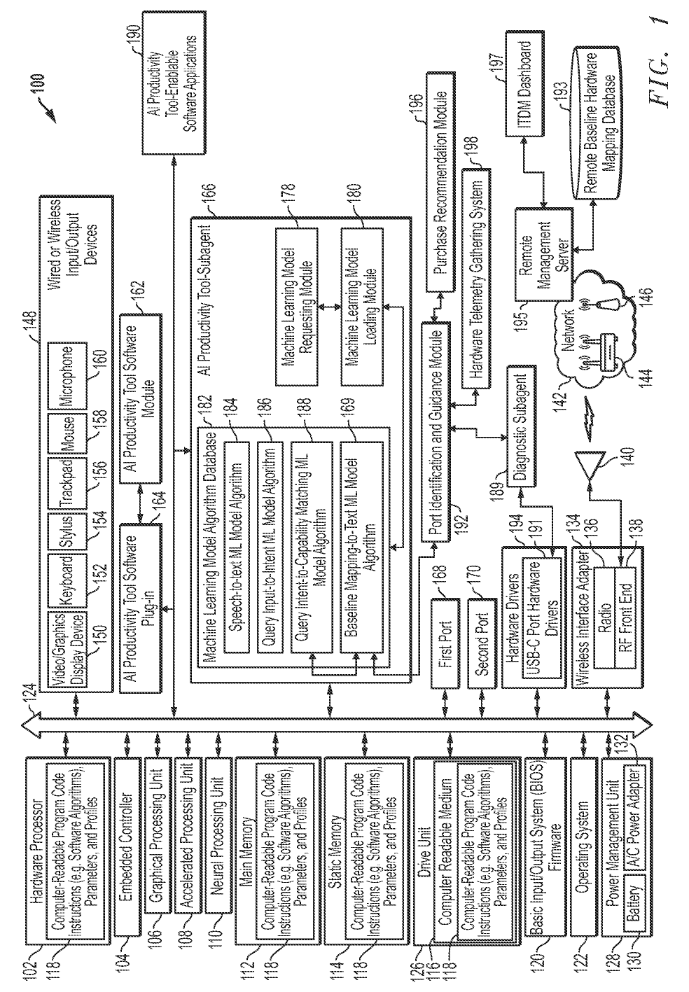

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer readable code instructions stored in main memory 112 (e.g., RAM) may be accessible by hardware processing resources using that main memory 112. Computer-readable program code instructions stored in static memory 114, main memory 112, or drive unit 126 may be involved in invoking such computer-readable program code instructions to main memory 112 according to embodiments herein. Additional components of the information handling system 100 may include one or more storage devices such as static memory 114 or drive unit 126. The information handling system 100 may include or interface with one or more communications ports 168, 170 for communicating with external devices, as well as various wired or wireless input and output (I/O) devices 148, such as a mouse 158, a trackpad 156, a stylus 154, a keyboard 152, a video/graphics display device 150, a microphone 160, or any combination thereof. Portions of an information handling system 100 may themselves be considered information handling systems 100.

Information handling system 100 may include devices or modules that embody one or more of the devices or execute instructions for one or more systems and modules. The information handling system 100 may execute computer-readable program code instructions (e.g., software algorithms) parameters, and profiles 118 that may operate on servers or systems, remote data centers, or on-box in individual client information handling systems according to various embodiments herein. In some embodiments, it is understood any or all portions of computer-readable program code instructions (e.g., software algorithms) parameters, and profiles 118 may operate on a plurality of information handling systems 100.

The information handling system 100 may include the hardware processor 102 such as a central processing unit (CPU) or other hardware processing resources (e.g., 104, 106, 108, 110). Any of the hardware processing resources may operate to execute computer readable code instructions that are either firmware or software code, such as those software systems and modules described herein in execution of orchestrating a plurality of capabilities from plural AI productivity tool software module 162. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer readable medium 116 storing computer-readable program code instructions (e.g., software algorithms) parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various wired or wireless I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU 110, APU 108, and/or others may execute one or more bus drivers in order to transmit this data between the information handling system 100 and the wired or wireless input/output devices 148 described herein. In an embodiment, the information handling system 100 may be in wired or wireless communication with the wired or wireless I/O devices 148 such as a keyboard 152, a mouse 158, video/graphics display device 150, stylus 154, trackpad 156, microphone 160, among other peripheral devices.

As described herein, the information handling system 100 further includes a video/graphics display device 150. The video/graphics display device 150 in an embodiment may function as a liquid crystal display (LCD), an organic light emitting diode (OLED), a flat panel display, or a solid-state display. It is appreciated that the video/graphics display device 150 may be wired or wireless and may be an external video/graphics display device 150 that allows a user to increase the desktop area by extending the desktop in an embodiment. Additionally, as described herein, the information handling system 100 may include or be operatively coupled to a cursor control device (e.g., a trackpad 156, or gesture or touch screen input), a stylus 154, and/or a keyboard 152, among others that allows the user to interface with the information handling system 100 via the video/graphics display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the wired or wireless I/O devices 148 according to the embodiments described herein. The present specification contemplates that the wired or wireless I/O devices 148 may be wired or wireless. Wired coupling to peripheral devices or power sources may be via plural data ports 168, 170 such as USB-C or USB-A ports.

A network interface device of the information handling system 100 may be wired or wireless such as shown with wireless interface adapter 134 that can provide wireless connectivity among devices such as with Bluetooth® or to a network 142, e.g., a wide area network (WAN), a local area network (LAN), wireless local area network (WLAN), a wireless personal area network (WPAN), a wireless wide area network (WWAN), or other network. In embodiments described herein, the wireless interface device 134 with its radio 136, RF front end 138 and antenna 140 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth ®, BLE, proprietary RF protocol, or other WPAN or WLAN protocols and plural such protocols may be used for communication with and among any wireless peripheral device to be paired or paired with the information handling system 100 or other information handling systems.

In other embodiments, a WAN, WWAN, LAN, and WLAN may each include an AP 144 or base station 146 used to operatively couple the information handling system 100 to a network 142 via a wireless interface adapter 134. In a specific embodiment, the network 142 may include macro-cellular connections via one or more base stations 146 or a wireless AP 144 (e.g., Wi-Fi), or such as through licensed or unlicensed WWAN small cell base stations 146. Connectivity may be via wired or wireless connection. For example, wireless network wireless APs 144 or base stations 146 may be operatively connected to the information handling system 100. Wireless interface adapter 134 may include one or more RF (RF) subsystems (e.g., radio 136) with transmitter/receiver circuitry, modem circuitry, one or more antenna RF (RF) front end 138 circuits, one or more wireless controller circuits, amplifiers, antennas 140 and other circuitry of the radio 136 such as one or more antenna ports used for wireless communications via multiple radio access technologies (RATs). The radio 136 may communicate with one or more wireless technology protocols.

In an embodiment, the wireless interface adapter 134 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof.

In some embodiments, a hardware processing resource executes computer-readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit. Accordingly, the present system encompasses a hardware processing resource executing computer-readable program code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable program code instructions, parameters, and profiles 118 or receives and executes computer-readable program code instructions, parameters, and profiles 118 responsive to a propagated signal, so that a hardware device connected to a network 142 may communicate voice, video, or data over the network 142. Further, the computer-readable program code instructions, parameters, and profiles 118 may be transmitted or received over the network 142 via the network interface device or wireless interface adapter 134.

The information handling system 100 may include a set of computer-readable program code instructions, parameters, and profiles 118 that may be executed to cause the computer system to perform any one or more of the methods or computer-based functions disclosed herein. For example, computer-readable program code instructions, parameters, and profiles 118 may be executed by a hardware processor 102, GPU 106, EC 104, APU 108, NPU 110, or any other hardware processing resource and may include software agents, or other aspects or components used to execute the methods and systems described herein. Various software modules comprising application computer-readable program code instructions, parameters, and profiles 118 may be coordinated by an operating system (OS) 122, and/or via an application programming interface (API) include a unified device API described herein. An example OS 122 may include Windows ®, Android ®, and other OS types. Example APIs may include Win 32, Core Java API, or Android APIs.

In an embodiment, the information handling system 100 may include a disk drive unit 126. The disk drive unit 126 and may include machine-readable program code instructions, parameters, and profiles 118 in which one or more sets of machine-readable program code instructions, parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a computer-readable medium for storage of one or more sets of machine-readable program code instructions, parameters, or profiles 118 described herein. The disk drive unit 126 or static memory 114 also contain space for data storage. Further, the machine-readable program code instructions, parameters, and profiles 118 may embody one or more of the methods as described herein. In a particular embodiment, the machine-readable program code instructions, parameters, and profiles 118 may reside completely, or at least partially, within the main memory 112, the static memory 114, and/or within the disk drive 126 during execution by the hardware processor 102, EC 104, APU 108, NPU 100, or GPU 106 of information handling system 100.

Main memory 112 or other memory of the embodiments described herein may contain computer-readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain computer-readable medium (not shown), such as NOR or NAND flash memory in some example embodiments. The applications and associated APIs, for example, may be stored in static memory 114 or on the disk drive unit 126 that may include access to a machine-readable code instructions, parameters, and profiles 118 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, the APU 108, the NPU 110, a video/graphic display device 150, or other wired or wireless I/O devices 148 such as the mouse 158, the stylus 154, the keyboard 152, and the trackpad 156 and other components that may require power when a power button has been actuated by a user. In an embodiment, the PMU 128 may monitor power levels and be electrically coupled to the information handling system 100 via a first port 168, a second port 170, or other ports in embodiments herein to provide this power. The PMU 128 may be coupled to the bus 124 to provide or receive data or machine-readable code instructions. The PMU 128 may regulate power from a power source such as the battery 130, or AC power adapter 132 such as from one or more ports 168, 170. In an embodiment, the battery 130 may be charged via the AC power adapter 132 and provide power to the components of the information handling system 100, via wired connections such as from one or more ports 168, 170 as applicable, or when AC power from the AC power adapter 132 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 116 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

In order to identify failed ports among a plurality of ports 168, 170 at the information handling system such as USB-C ports, the hardware processor 102 or other hardware processing device (e.g., 104, 106, 108, 110) may execute computer-readable program code instructions of a diagnostic subagent 189. Execution of the computer-readable program code instructions of a diagnostic subagent 189 causes the information handling system 100 to detect damage to a first port 168 or second port 170 at the information handling system 100. In an embodiment, the execution of the computer-readable program code instructions of a diagnostic subagent 189 causes the information handling system 100 to determine if the first port 168, second port 170, or any other port is damaged such that either or both data or power is not transmitted via the ports 168, 170. The execution of the computer-readable program code instructions of a diagnostic subagent 189 may also generate diagnostic port data describing a first port 168, for example, that is damaged among a plurality of ports 168, 170 at the information handling system 100.

In an example embodiment, the execution of the computer-readable program code instructions of a diagnostic subagent 189 may access a hardware driver 194 for the first port 168, such those USB-C port hardware drivers 191 associated with the USB-C ports. Access to these port hardware drivers 191 may allow the diagnostic subagent 189 to request that an internal loopback test be conducted. This internal loopback test may include sending specific test patterns or packets through the first port 168 (e.g., a USB-C port) with the port hardware drivers 191 “listening” to receive the same data that was transmitted, checking for any errors in transmission, timing, or signal integrity. Where any errors in this process are detected, the diagnostic subagent 189 may return diagnostic port data to a port identification and guidance module 192 of damage to data or power propagation at the first port 168 for processing as described herein. In an embodiment, the diagnostic subagent 189 may conduct scheduled internal loopback tests of each port 168, 170 with the internal loopback tests periodically describing the operational state (e.g., damaged or operational) of each of the available ports such as the first port 168 and second port 170. In another embodiment, the diagnostic subagent 189 may set a process by which each hardware driver 194 associated with each of the first port 168 and second port 170 may conduct this internal loopback test in every instance of a peripheral device being operatively coupled to the port 168, 170. This may be conducted by their respective port hardware drivers 191 (e.g., USB-C port driver) such that the diagnostic subagent 189 is informed if and when any of the ports 168, 170 have been found to be damaged for data transmissions. Additionally, the execution of the computer-readable program code instructions of the diagnostic subagent 189 may interface with the PMU 128 to test for power transmission at a power pin of the individual ports 168, 170.

Additionally, or alternatively, user input may be used to prompt the diagnostic subagent 189 to run this internal loopback test or any other test to determine the operability of the first port 168 and second port 170. For example, a user may operatively couple an external video/graphics display device 150 to the information handling system 100 by connecting a power/data cable to one of the first port 168 or second port 170 (e.g., USB-C ports). If one of the ports 168, 170 are damaged, the user may detect this in the images and video presented on the video/graphics display device 150. This may prompt the user to interface with the AI productivity tool software module 162 by providing user-query input requesting an explanation and/or solution to fix the perceived issues associated with the images and video presented on the video/graphics display device 150. As described in embodiments herein, the information handling system 100 includes an AI productivity tool software module 162 and an AI productivity tool software plug-in 166 to receive this or similar user-query input and provide that user-query input to the AI productivity tool subagent 166. The AI productivity tool software module 162 may include an original equipment manufacturer (OEM) AI productivity tool with a set of capabilities that are executable on the information handling system 100 in embodiments of the present disclosure. In the embodiments herein, the user-query input may include audio input received from, for example, the microphone 160. In another embodiment, the user-query input may include text input by the user by the keyboard 152. In an embodiment, the execution of the computer-readable program code instructions 118 of the AI productivity tool subagent 166 by the hardware processor 102 or any other hardware processing device selects among a plurality of available ML module algorithms 184, 186, 188 maintained within a ML model algorithm database 182 for use with execution of the plurality of AI productivity tool software module 162.

The AI productivity tool software module 162 may invoke one or more sets of capabilities of AI productivity tool-enablable software applications executable on the information handling system 100 according to embodiments of the present disclosure such as those capabilities associated with the diagnostic subagent 189 to test the operation and operability of each of the first port 168 and second port 170. As described herein, the computer-readable program code instructions 118 of the AI productivity tool software module 162 with an AI productivity tool subagent 166 as well as available ML module algorithms 184, 186, 188 may be executed by a hardware processor 102 or other ML model algorithm execution provider hardware processing resource on the information handling system 100.

The execution of code instructions of the AI productivity tool subagent 166 as well as available ML module algorithms 184, 186, 188 thereby allow the processes of the AI productivity tool software module 162 to identify responsive capabilities from among their respective sets of capabilities and respond to received user query inputs according to methods described herein. The execution of the AI productivity tool subagent or subagent 166 as well as available ML module algorithms 184, 186, 188 for the AI productivity tool software module 162 may be carried out on-the-box such that a wired or wireless network connection to a network is not necessary for operation of the method. In another embodiment, some modules, databases, and/or processing resources such as ML module algorithms 184, 186, 188 may be maintained on a remote server (e.g., remote management server 195) such that a wired or wireless network connection can be made with these remote servers and the method may be implemented as described herein.

The AI productivity tool software module 162 may include any artificial intelligence-based productivity tool to assist in interfacing with and execution of the AI productivity tool-enablable software applications 190 and receive user query inputs from a user and generate responses as responsive capability intent actions at an information handling system 100. The AI productivity tool software module 162 may be loaded on-the-box by an OEM manufacturer or via uploads in software from one or more independent software vendor (ISVs), such as an operating system ISV. The AI productivity tool software module 162 may include chatbot features, virtual assistant features, and other artificial intelligence features that allow a user to provide input to the information handling system 100 and, with generative artificial intelligence processing of the user-query input, execute one or more responsive capabilities from various sets of capabilities that include hardware operations, functions, software services such as by using one or more AI productivity tool-enablable software applications 192. Examples of some types of AI productivity tool software modules 162 may include Cortana ® by Microsoft ®, Copilot ® by Microsoft ®, Siri ® by Apple ® Inc., Gemini ® by Google AI®, ChatGPT ® by OpenAI ®, and Amazon Alexa ® by Amazon ®, among others. It is appreciated that the information handling system 100 may include any proprietary AI productivity tool software module 162 that is an OEM AI productivity tool installed by an information handling system 100 manufacturer and used to interface with the information handling system 100 and the operations thereon. In various embodiments, the hardware processor 102 or other alternative hardware processing resources of the information handling system 100 may execute computer-readable program code instructions of the AI productivity tool software module 162 and the AI productivity tool plug-in 164 to monitor for user input for a user query at a microphone 160, keyboard 152, or other input device for the AI productivity tool subagent 166 to engage in determining capability intent actions responsive to the user-query input.

The AI productivity tool plug-in 166 may be any software or firmware that allows the AI productivity tool subagent 166 to perform processes of the AI productivity tool software module 162 to determine capability intent actions responsive to a user-query input at the information handling system 100 based on specific types of user-query input (e.g., typed, spoken words, images, etc.) provided from the user, and in embodiments of the present disclosure. The AI productivity tool plug-in 164 may be used by the AI productivity tool software module 162 and AI productivity tool subagent 166 to interface with any number of AI productivity tool-enablable software applications 192 executing or executable on the information handling system 100 according to embodiments herein.

In an embodiment, the AI productivity tool subagent 166 may be used to direct the execution of various modules in support of one or more identified productivity tool operations by the AI productivity tool-enablable software application 190 and AI productivity tool software module 162 in responding to user query inputs described herein. Additionally, the AI productivity tool subagent 166 may be provided with access to the BIOS 120 and OS 122 of the information handling system 100. Example of identified productivity tool operations include execution of code instructions of the AI productivity tool software module 162 to determine user-query intent values, match these with generated capability intents, and to execute code instructions of the AI productivity tool-enablable software applications 190 such as the diagnostic subagent 189 to conduct commensurate capability intent actions pursuant to the user’s query input.

In an embodiment, during operation, the hardware processor 102 or other hardware processing resource (e.g., EC 104, GPU 106, CPU, APU 108, or NPU 110) executes computer-readable program code instructions of the AI productivity tool subagent 166. The AI productivity tool subagent or subagents 166 may engage with a machine learning model requesting module 178 and machine learning model loading module to have one or more ML module algorithms 184, 186, 188 loaded and executed on the hardware processor in order to, initially, determine the query intent value of a user-query input and to correlate it with a capability intent action to be conducted responsive to the received user-query inputs.

In example embodiments herein, the ML module algorithms 184, 186, 188 may include a query input-to-intent ML model algorithm 186 that receives the user-query input, and with an embedding algorithm generates a vectorized query intent value for the user-query input for later correlation with a capability intent value. In embodiments where the user-query input is in audio form, the AI productivity tool subagent 166 may invoke the execution of a speech-to-text ML model algorithm 184 to initially convert this audio into text for use with the query input-to-intent ML model algorithm 186 to generate the vectorized query intent value for the user-query input for later correlation with a capability intent value as described herein. In an example embodiment, the ML module algorithms 184, 186, 188 may also include a query intent-to-capability matching ML model algorithm 188. The query intent-to-capability matching ML model algorithm 188 receives the vectorized query intent value from the execution of the query input-to-intent ML model algorithm 186 as input and then matches the vectorized query intent value to a vectorized capability intent value associated with the AI productivity tool-enablable software application 192 via a similarity correlation algorithm for lexical or semantic matching to identify a responsive capability or responsive text via an LLM that can serve as the responsive capability intent action or recommendation text responsive to a user-query input.

In embodiments of the present disclosure, the capabilities may include capabilities associated with the AI productivity tool-enablable software application 192 as accessible through the AI productivity tool software module 162. Example AI productivity tool-enablable software applications 192 may include Dell ® Optimizer®, Dell® SupportAssist®, the diagnostic subagent 189, as well as any other AI productivity tool-enablable software applications 192 described herein that can change features, settings, or other actions on the information handling system. Additional, example AI productivity tool-enablable software applications 192 may include the diagnostic subagent 189, the port identification and guidance module 192, and the purchase recommendation module 196 in embodiments herein.

Whether the diagnostic subagent 189 causes the internal loopback test to be conducted in response to a periodic scheduling of the test or in response to the user-query input, the detection of a damaged port 168, 170 causes a number of operations to be executed to both identify the damaged port 168, 170 to the user, direct the user to other ports 168, 170 that can be used to operatively couple a peripheral device or other hardware device to the information handling system 100, and generate or create a purchase order providing details related to what hardware devices the user could purchase to compensate for the damaged port 168, 170. In an embodiment, therefore, the hardware processor 102 or other hardware processing device (e.g., 104, 106, 108, 110) may execute computer-readable program code 118 of a port identification and guidance module 192 to gather baseline port mapping data describing mapping of hardware and ports within the information handling system 100 and capabilities of that hardware and ports. In an embodiment, the port identification and guidance module 192 may access a remote baseline hardware mapping database 193 at the remote management server 195 that maintains this baseline port mapping data. In an embodiment, the remote baseline hardware mapping database 193 may be maintained by a manufacturer of the information handling system 100 and may include purchasing data describing the information handling system 100 purchased by the user along with all hardware, firmware, and software components including locations and capabilities for the model/type of information handling system 100.

After the baseline port mapping data has been identified, the AI productivity tool subagent 166 may use the diagnostic port data describing which of the ports 168, 170 are damaged, the baseline port mapping data, and hardware telemetry data for the information handling system 100 and peripheral devices as input into a baseline mapping-to-text ML model algorithm 169. In an embodiment, the execution of computer-readable program code of a hardware telemetry gathering system 198 by a hardware processor 102, may allow the information handling system to gather current hardware telemetry data and may include the execution of Dell Support Assist Software Application, Dell Display and Peripheral Device Manager Software Application, Dell Optimizer Software Application, or others. Invocation of the baseline mapping-to-text ML model algorithm 169 with the diagnostic port data, baseline port mapping data, and hardware telemetry data for the information handling system 100 and peripheral devices as input provides, as output, user-guided text describing which port to use in lieu of the port 168, 170 that is damaged. This user-guided text may be presented to the user at a video/graphics display device 150 or may even be presented via audio output at a speaker that directs the user to use the other working port 168, 170 and, in an embodiment, describes or shows in an image where the other working port 168, 170 is located on the information handling system 100. This guidance will allow the user to make immediate use of the peripheral device or other hardware device being operatively coupled to the information handling system 100 while a solution regarding how to deal with the damaged port 168, 170 is being generated.

As such, during operation, the hardware processor 102 or other hardware processing device (e.g., 104, 106, 108, 110) may execute the computer-readable program code instructions of a purchase recommendation module 196 to create a purchase order based on the baseline port mapping data that identifies purchasable hardware that can be used as a substitute to the first port that is damaged. For example, the information handling system 100 may have had a first port 168 and a second port 170 used by the user to operatively couple two different peripheral devices or other hardware devices to the information handling system 100. With, for example, the first port 168 being found to be damaged and the user being made aware of the damaged first port 170 via execution of the diagnostic subagent 189 or observations during operation of the coupled peripheral device or other hardware device, the functionality of the peripheral device or other hardware device operatively coupled to the information handling system 100 at the first port 168 is now lost. In order to provide options, the purchase recommendation module 196 may receive the baseline port mapping data received at the port identification and guidance module 192 as input and identify various additional hardware that may replace the damaged first port 168 to generate a purchase order and recommendation. For example, the purchase order may include recommendations to purchase a docking station that would include not only another port to replace the damaged first port 168 but also additional ports as well as a variety of different ports that may be used to operatively couple the peripheral devices or other hardware device to the information handling system 100. Because the baseline port mapping data used by the purchase recommendation module 196 is specific to the user’s information handling system 100, the selection and recommendation of the docking station will be customized to the current hardware within the information handling system 100 identified by baseline port mapping data thereby directing the user to specific docking stations that will fulfill the user’s needs and act as a substitute for the damaged first port 168 as well as providing increased functionality.

In some embodiments, a hardware processor (e.g., 102, 104, 106, 108, 110) executing computer-readable program code instructions of the purchase recommendation module 196, based on the baseline port mapping data received as well as hardware telemetry and other data specific to the user’s information handling system 100, may match with and generate other options besides suggesting the purchase of a docking station. For example, the baseline port mapping data input may match with an indication that the information handling system 100 itself has reached a level of obsolescence such that the purchase of a new information handling system 100 with up-to-date technology should be contemplated by the user. Thus, the purchase order generated by the purchase recommendation module 196 may not only present relatively immediate solutions to the current problem of the defective first port 168, but the purchase order may also provide relatively more long-term solutions such as the purchase of a new information handling system 100 as well. Thus, the purchase recommendation module 196 executes an LLM to generate a purchase order with a purchase order template that can be presented to the user (e.g., via the video/graphics display device 150) that provides an array of options that can specifically address the issues encountered by the damaged first port 168. Indeed, because the baseline port mapping data as well as the telemetry data for the user’s information handling system 100 includes data specifying which peripheral devices are often used and operatively coupled to the information handling system 100 input to the purchase recommendation module 196, customization of the generated purchase order also identifies current needs as well as potential needs of the future by the user such as if and when additional peripheral devices such as another external video/graphics display device 150 may be coupled to the information handling system 100 A hardware telemetry gathering system 198 such as Dell® SupportAssist® software application or Dell ® Display and Peripheral Device Manager software application may execute to gather telemetry of hardware components and peripheral devices used at the information handling system 100. In an embodiment, the baseline port mapping data may be updated with telemetry data for the user’s information handling system 100 including operational capabilities and health of the hardware components like the first port 168 and other hardware components in the information handling system 100.

In an embodiment, the baseline port mapping data may also include and be updated with user productivity metrics from telemetry data for the user’s information handling system 100 that describe, in an embodiment, any and all reductions in user productivity resulting from the detection of non-use of the damaged first port 168. These metrics may include, for example, the lack of a previous peripheral device being operatively coupled to the information handling system 100, a reduction in hardware processing metrics indicative of lower user productivity, disablement or non-use of certain software applications that require specific peripheral devices to be present (e.g., a stylus not being used for a drawing software application), and the like. This data may further be input into the purchase recommendation module 196 to match with and generate recommendations to the user via the purchase order that addresses the unavailability of the damaged first port 168.

In an embodiment, the generated purchase order from the purchase recommendation module 196 may also be transmitted to an ITDM operating an ITDM dashboard 197. The ITDM may be notified so that the user of the information handling system 100 may receive further IT support from the ITDM in deciding whether to purchase additional hardware, which additional hardware to purchase, and whether a new information handling system 100 should be ordered for the user. Because the ITDM, in some cases, may serve as the purchasing agent for the user or a plurality of users within an enterprise, the ITDM may simply review the issues resulting from the damaged first port 168, review the suggested recommendations presented on the purchase order, and purchase additional hardware on behalf of the user.

The systems and methods described herein, therefore, provides port resiliency. The systems and methods described herein execute to further assist ITDMs or users to make purchasing decisions related to the issues associated with the damaged first port 168 thereby increasing user satisfaction and user productivity. Although some recommendations in the generated purchase order as well as the audio, text, or image recommendations generated by the port identification and guidance module 192 guiding the user to use a different port (e.g., second port 170) may temporarily solve the issues with the damaged first port 168, user productivity may still be maintained at a certain level until more substantial or permanent solutions are sought after by the user and/or ITDM. This allows for flexibility and customization of the user’s unique issues such that the best temporary and permanent solutions are presented as options to the user. Additionally, the generated purchase order may further provide information to the user or ITDM that would not have been considered as valid options otherwise thereby broadening the number of possible solutions further for the user and/or ITDM.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel ® brand processor, AMD ® brand processors, Qualcomm ® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

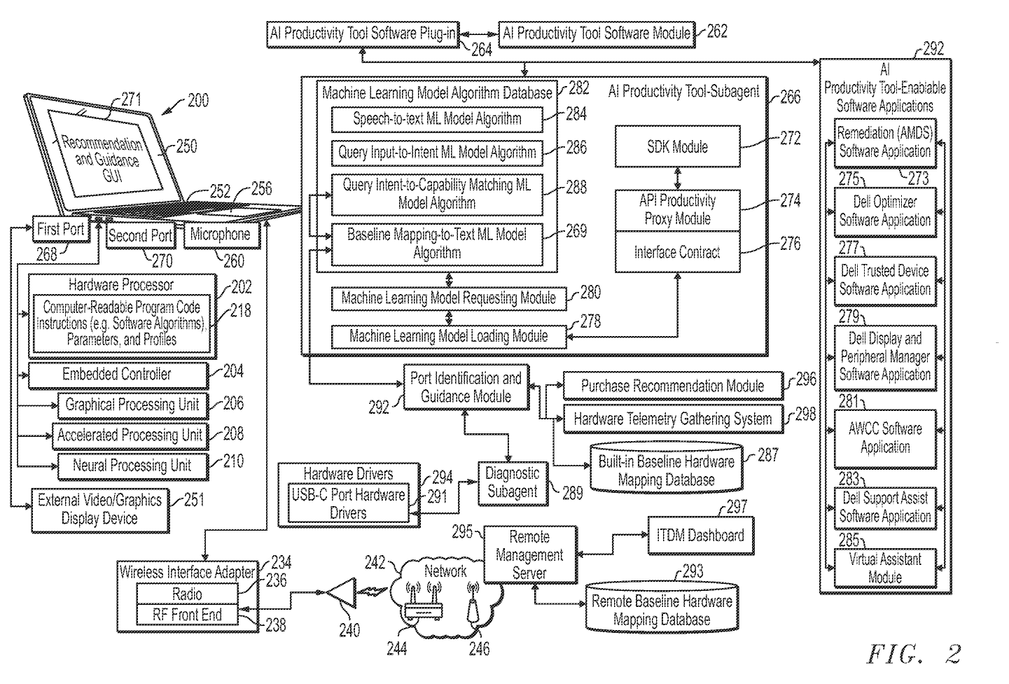

FIG. 2 is a graphic and block illustrating an information handling system executing computer-readable program code instructions of an AI productivity tool operating to provide port resiliency and AI recommendations for failed ports at the information handling system according to another embodiment of the present disclosure. As described herein, the information handling system 200 in FIG. 2 is shown as a laptop-type information handling system 200. The information handling system 200 may include a video display device 250 to provide output to the user as well as a keyboard 252, a touchpad 256, and microphone 260 for the user to provide input to the information handling system 200. The information handling system 200 may be operationally coupled to one or more external input/output devices (e.g., 148, FIG. 1) such as an external video/graphics display device 251, or a power source via a first port 268, second port 270, or other ports (not shown). It is appreciated that other types of information handling systems may be used and the information handling system 200 presented in FIG. 2 is presented as an example of an information handling system 200 that can be used with the systems and methods described herein.

As described herein, the system and methods described herein may be used by a user to resolve issues associated with a detected damaged port such as first port 268 that is a USB-C port at the information handling system 200. Because modern information handling systems 200 primarily use USB-C ports to operatively couple peripheral devices and other hardware devices as well as power to the information handling system 200, damage of these USB-C ports may result in reduced user productivity. For example, a user may have a habit of transporting the information handling system 200 from a worksite to a home office. When the user transports the information handling system 200 to a home office, the user may use the first port 268 to operatively couple the external video/graphics display device 251 to the information handling system 200. Because USB-C type ports may fail, this first port 268 may become damaged thereby preventing or limiting the use of the external video/graphics display device 251, other external peripheral I/O devices, or limit access to power. It is appreciated that the present example of the external video/graphics display device 251 is presented in FIG. 2 as an example of a peripheral device or other hardware device that may be affected by a damaged port 268, 270 at the information handling system 200. Accordingly, the present specification contemplates that other peripheral devices and/or hardware devices such as I/O devices (e.g., 148 in FIG. 1) may be affected by a damaged port 268, 270 at the information handling system 200 and the present specification contemplates these other examples.

In order to initially identify one or more failed ports 268, 270 at the information handling system (e.g., USB-C ports), the hardware processor 202 or other hardware processing device (e.g., 204, 206, 208, 210) may execute computer-readable program code instructions of a diagnostic subagent 289. Execution of the computer-readable program code instructions of a diagnostic subagent 289 causes the information handling system 200 to detect damage to a first port 268 or second port 270 at the information handling system 200 as well as any other ports present at the information handling system 200. The execution of the computer-readable program code instructions of a diagnostic subagent 289 may also generate diagnostic port data describing that, in the present example, the first port 268 is damaged while the second port 270 remains operable at the information handling system 200.

In an example embodiment, the execution of the computer-readable program code instructions of a diagnostic subagent 289 may identify a damaged port 268, 270 by accessing a hardware driver 294 such those USB-C port hardware drivers 291 associated with the USB-C ports which includes the first port 268. Access to these USB-C port hardware drivers 291 may allow the diagnostic subagent 289 to request that an internal loopback test be conducted. As described herein, this internal loopback test may include sending specific test patterns or packets through the USB-C port with the USB-C port hardware drivers 291 “listening” to receive the same data that was transmitted, checking for any errors in transmission, timing, or signal integrity. Where any errors are detected in this process, the diagnostic subagent 289 may return a signal to a port identification and guidance module 292 for processing described herein. In an embodiment, the diagnostic subagent 289 may conduct scheduled internal loopback test with the internal loopback tests periodically describing the operational state (e.g., damaged or operational) of each of the available ports such as the first port 268 and second port 270. In another embodiment, the diagnostic subagent 289 may set a process by which each hardware driver 294 associated with each of the first port 268 and second port 270 may conduct this internal loopback test in every instance of a peripheral device being operatively coupled to the port 268, 270. For example, when the user returns home and operatively couples the external video/graphics display device 251 to the information handling system 200 via the first port 268, this action may trigger the USB-C port hardware driver 191 associated with the first port 268 to run this internal loopback test. This process may be conducted by each respective USB-C port hardware driver 291 or other type of hardware driver 294 associated with each port 268, 270 such that the diagnostic subagent 289 is informed if and when any of the ports 268, 270 have been found to be damaged.

Additionally, the execution of the computer-readable program code instructions of the diagnostic subagent 289 may interface with the PMU (e.g., 128, FIG. 1) to test for power transmission at a power pin of the individual ports 268, 270. For example, the diagnostic subagent 289 may periodically execute built-in software or firmware diagnostics that monitor power draw and voltage levels via the PMU that periodically tests that identify issues with power transmissions of each of the available ports such as the first port 268 and second port 270. In another embodiment, the diagnostic subagent 289 may set a process by which each hardware driver 294 associated with each of the first port 268 and second port 270 may execute this built-in software or firmware diagnostics that monitor power draw and voltage levels that periodically tests that identify issues with power transmissions of each of the available ports such as the first port 268 and second port 270. For example, when the user returns home and operatively couples the external video/graphics display device 251 to the information handling system 200 via the first port 268, this action may trigger the USB-C port hardware driver 191 associated with the first port 268 to run this built-in software or firmware diagnostics.

Additionally, or alternatively, user input may be used to prompt the diagnostic subagent 289 to run this internal loopback test or any other test such as a PMU power test to determine the operability of the first port 268 and second port 270. For example, a user may operatively couple the external video/graphics display device 251 to the information handling system 200 by connecting a power/data cable to the first port 268 (e.g., a USB-C port) once the user returns to the home office according to the example described herein. If the first port 268 is damaged, such as due to the repetitive insertion of the power/data cable into the first port 268 over time, the user may detect this by seeing problems or distortions in the images and video presented on the external video/graphics display device 251. Similar problems or distortions may occur with other externally coupled peripheral devices. Other problems may be detected when a power source is operatively coupled to the first port 268, but battery charging fails to occur. It may be unclear to a user what the cause of the problems are or that port 268 may be damaged since the first port 268 may not look damaged.

The detection of problems or distortions, such as in the images and video presented on the external video/graphics display device 251 in an example embodiment, may prompt the user to interface with the AI productivity tool software module 262. As described herein, the user may provide user-query input requesting an explanation and/or solution to fix the perceived visual issues associated with the images and video presented on the external video/graphics display device 251. The hardware processor 202 executing computer-readable program code instructions of a hardware telemetry gathering system 298 may detect which port 268, 270 that the external video/graphics display device 251 is operatively coupled to in addition to detecting other peripheral devices at other ports 268, 270 in embodiments. This hardware telemetry data for which peripheral devices, such as external video/graphics display device 251, are operatively coupled to ports 268 and 270 are forwarded to a built-in baseline hardware mapping database 287. Further, a history of which peripheral devices or a power source are typically or repeatedly coupled with which ports 268 and 270 may be gathered within the built-in baseline hardware mapping database 287.

As described in embodiments herein, the information handling system 200 includes an AI productivity tool software module 262 and an AI productivity tool software plug-in 266 to receive this or similar user-query input and provide that user-query input to the AI productivity tool subagent 266. In this example embodiment, this user-query input may include audio recorded at the microphone 260 of the user saying “please fix the issues with my screen blinking” where the user is detecting a blinking distortion in the image/video presented on the external video/graphics display device 251. It is appreciated that other distortions may be detected by the user and that other corresponding user-query input may be provided by the user in other embodiments. The AI productivity tool software module 262, in an embodiment, may include an OEM AI productivity tool with a set of available capabilities that are executable on the information handling system 200 in embodiments of the present disclosure. In the embodiments herein, the user-query input may include audio input received from, for example, the microphone 260, text input by the user by the keyboard 252, or other forms of user-query input using any type of peripheral device. In an embodiment, the execution of the computer-readable program code instructions 218 of the AI productivity tool subagent 266 by the hardware processor 202 or any other hardware processing device selects among a plurality of available ML module algorithms 284, 286, 288 maintained within a ML model algorithm database 282 for use with execution of the plurality of AI productivity tool software module 262.

The AI productivity tool software module 262 may invoke one or more sets of capabilities of AI productivity tool-enablable software applications executable on the information handling system 200 according to embodiments of the present disclosure These one or more sets of capabilities of AI productivity tool-enablable software applications may include those capabilities associated with the diagnostic subagent 289 to test the operation and operability of each of the first port 268 and second port 270, the port identification and guidance module 292 to generate responsive recommendation text, audio, or images, or the purchase recommendation module 296 to generate a recommendation purchase order. As described herein, the computer-readable program code instructions 218 of the AI productivity tool software module 262 with an AI productivity tool subagent 266 as well as available ML module algorithms 284, 286, 288 may be executed by a hardware processor 202 or other ML model algorithm execution provider hardware processing resource on the information handling system 200.

The execution of code instructions of the AI productivity tool subagent 266 as well as available ML module algorithms 284, 286, 288 thereby allow the processes of the AI productivity tool software module 262 to identify responsive capabilities from among their respective sets of capabilities and respond to received user query inputs according to methods described herein. The execution of the AI productivity tool subagent or subagent 266 as well as available ML module algorithms 284, 286, 288 for the AI productivity tool software module 262 may be carried out on-the-box such that a wired or wireless network connection to a network is not necessary for operation of the method. In another embodiment, some modules, databases, and/or processing resources such as ML module algorithms 284, 286, 288 may be maintained on a remote server (e.g., remote management server 295) such that a wired or wireless network connection can be made with these remote servers and the method may be implemented as described herein.

In an embodiment, the execution of the computer-readable program code instructions of the AI productivity tool subagent 266 may call a software development kit (SDK) module 272. The SDK module 272 may include any computer-readable program code instructions that is executed by the hardware processor 202 or other hardware processing resource to request that a ML module algorithms 284, 286, 288 that may be invoked to support the identification of, in an embodiment, one or more capability intent action based on received user-query inputs from a user at the AI productivity tool software module 262 as well as other inputs in embodiments herein. Additionally, the selected ML module algorithms 284, 286, 288 for a similar or common identified AI productivity-tool operation type may satisfy an interface contract 276 requested by the AI productivity tool subagent 266 such that the query intent value from the user-query inputs may be interpreted and an available capability associated with one of the plurality of AI productivity tool-enablable software applications 292 as the capability intent action can be matched to the user’s query input. The interface contract 276 described herein defines the requirements that selected ML module algorithms 284, 286, 288 are to have in order to be able receive a specific type of input from the AI productivity tool software module 262, the AI productivity tool subagent 266, or any AI productivity tool-enablable software application 292 and to provide a specific type of output to the AI productivity tool subagent 266, the AI productivity tool software module 262, and/or AI productivity tool-enablable software applications 292. In an embodiment, the interface contract 276 is generated by an AI productivity proxy API 274 invoked by the SDK module 272 in order to identify the similar or common productivity-tool operation type ML module algorithms 284, 286, 288 that provides the appropriate output to the AI productivity tool subagent 266.

The AI productivity tool software module 262 may include any artificial intelligence-based productivity tool to assist in interfacing with and execution of the AI productivity tool-enablable software applications 290 and receive user query inputs from a user and generate responses as responsive capability intent actions at an information handling system 200. Again, in the case of the user requesting to find out what is wrong with the operation of the external video/graphics display device 251, other peripheral devices, or power charging, one of potentially a plurality of responsive capabilities may be identified and may include responsive capabilities associated with the operation of the diagnostic subagent 189 and port identification and guidance module 292 described herein.

The AI productivity tool software module 262 may be loaded on-the-box by an OEM manufacturer or via uploads in software from one or more independent software vendor (ISVs), such as an operating system ISV. The AI productivity tool software module 262 may include chatbot features, virtual assistant features, and other artificial intelligence features that allow a user to provide input to the information handling system 200 and, with generative artificial intelligence processing of the user-query input, execute one or more responsive capabilities from various sets of capabilities that include hardware operations, functions, software services such as by using one or more AI productivity tool-enablable software applications 292. It is appreciated that the information handling system 200 may include any proprietary AI productivity tool software module 262 that is an OEM AI productivity tool installed by an information handling system 200 manufacturer and used to interface with the information handling system 200 and the operations thereon. In various embodiments, the hardware processor 202 or other alternative hardware processing resources of the information handling system 200 may execute computer-readable program code instructions of the AI productivity tool software module 262 and the AI productivity tool plug-in 264 to monitor for user input for a user query at a microphone 260, keyboard 252, or other input device for the AI productivity tool subagent 266 to engage in determining capability intent actions responsive to the user-query input.

The AI productivity tool plug-in 266 may be any software or firmware that allows the AI productivity tool subagent 266 to perform processes of the AI productivity tool software module 262 to determine capability intent actions responsive to a user-query input at the information handling system 200 based on specific types of user-query input (e.g., typed, spoken words, images, etc.) provided from the user, and in embodiments of the present disclosure. The AI productivity tool plug-in 264 may be used by the AI productivity tool software module 262 and AI productivity tool subagent 266 to interface with any number of AI productivity tool-enablable software applications 292 executing or executable on the information handling system 200 according to embodiments herein. Example AI productivity tool-enablable software applications 292 may include Dell ® Optimizer® software application 275, Dell® SupportAssist® software application 283, Remediation (AMDS) software application 273, Dell® Trusted Device software application 277, Dell® display and peripheral device manager software application 279, Alienware ® Command Center (AWCC) software application 281, and a virtual assistant module 285 along with the diagnostic subagent 289 that can change features, settings, or other actions on the information handling system. Other examples of AI productivity tool-enablable software applications 292 with responsive capabilities may include the diagnostic subagent 289, the port identification and guidance module 292, or the purchase recommendation module 296 according to other embodiments herein.

In an embodiment, the AI productivity tool subagent 266 may be used to direct the execution of various modules in support of one or more identified productivity tool operations by the AI productivity tool-enablable software application 290 and AI productivity tool software module 262 in responding to user query inputs described herein. Additionally, the AI productivity tool subagent 266 may be provided with access to the BIOS and OS (e.g., 120 and 122 of FIG. 1) of the information handling system 200 which may or may not control the operations of the hardware drivers 294 such as the USB-C port hardware drivers 191. Example of identified productivity tool operations include execution of code instructions of the AI productivity tool software module 262 to determine user-query intent values, semantically or lexically match these with generated capability intents, and to execute code instructions of the AI productivity tool-enablable software applications 290 such as the diagnostic subagent 289, the AI productivity tool-enablable software applications 292, or the purchase recommendation module 296 to conduct commensurate capability intent actions pursuant to the user’s query input when a port 289 or 270 is detected as damaged.

In an embodiment, during operation, the hardware processor 202 or other hardware processing resource (e.g., EC 204, GPU 206, CPU, APU 208, or NPU 210) executes computer-readable program code instructions of the AI productivity tool subagent 266. The AI productivity tool subagent or subagents 266 may engage with a machine learning model requesting module 278 and machine learning model loading module 280 to have one or more ML module algorithms 284, 286, 288 loaded and executed on the hardware processor in order to, initially, determine the query intent value of a user-query input and to semantically or lexically correlate it with a capability intent action to be conducted responsive to the received user-query inputs.

In example embodiments herein, the ML module algorithms 284, 286, 288 may include a query input-to-intent ML model algorithm 286 that receives the user-query input (e.g., “please fix the issues with my screen blinking”), and with an embedding algorithm generates a vectorized query intent value for the user-query input for later semantic or lexical correlation with a capability intent value. In embodiments where the user-query input is in audio form, the AI productivity tool subagent 266 may invoke the execution of a speech-to-text ML model algorithm 284 to initially convert this audio into text for use with the query input-to-intent ML model algorithm 286 to generate the vectorized query intent value for the user-query input for later correlation with a capability intent value as described herein. In an example embodiment, the ML module algorithms 284, 286, 288 may also include a query intent-to-capability matching ML model algorithm 288. The query intent-to-capability matching ML model algorithm 288 receives the vectorized query intent value from the execution of the query input-to-intent ML model algorithm 286 as input and then matches semantically or lexically the vectorized query intent value to a vectorized capability intent value associated with the AI productivity tool-enablable software application 292 via a similarity correlation algorithm for lexical or semantic matching to identify a responsive capability that can serve as the capability intent action responsive to a user-query input. For example, cosine similarity search may be conducted between query intent values and available capability intent values. Thus, a diagnostic capability associated with the diagnostic subagent 189 may be identified as a responsive capability that can initiate an internal loopback test to test the operability of the first port 268, second port 270, or any other port of the information handling system 200.

Whether the diagnostic subagent 289 causes the internal loopback test to be conducted in response to a periodic scheduling of the test or in response to the user-query input, the detection of a damaged port 268, 270 causes a number of further responsive capability operations to be executed to both identify the damaged port 268, 270 to the user, direct the user to other ports 268, 270 that can be used to operatively couple a peripheral device or other hardware device to the information handling system 200, and generate or create a purchase order providing details related to what hardware devices the user could purchase to compensate for the damaged port 268, 270. In an embodiment, therefore, the hardware processor 202 or other hardware processing device (e.g., 204, 206, 208, 210) may execute computer-readable program code 218 of a port identification and guidance module 292 to gather baseline port mapping data describing mapping of hardware within the information handling system 200 including port 268, 270 locations on the information handling system 200 as well as capabilities of that hardware and hardware telemetry data updates to that baseline port mapping data of detected peripheral devices coupled to those ports 268, 270 or typically coupled to those ports 268, 270 by a user. In an embodiment, the port identification and guidance module 292 may access a remote baseline hardware mapping database 293 at the remote management server 295 that maintains this baseline port mapping data. Remote baseline port mapping data may include physical location of ports or images of port locations of models of information handling systems similar to the user’s information handling system 200 identified through purchase data, serial number, description, or the like and drawn from a stored “as-built” golden configuration survey as baseline port mapping data. In an embodiment, the remote baseline hardware mapping database 293 may be maintained by a manufacturer of the information handling system 200 and may include purchasing data describing the information handling system 200 purchased by the user along with all hardware, firmware, and software components in the information handling system 200. Additionally, or alternatively, this remote baseline port mapping data received and updated as built-in baseline port mapping data to include states of ports 268, 270 and peripheral devices operatively or typically coupled thereto. This updated built-in baseline port mapping data may be maintained on a built-in baseline hardware mapping database 287 maintained on-the-box at the information handling system 200. This port mapping data may be retrieved and updated via periodic execution of a capability associated with any AI productivity tool-enablable software applications 292 as updated or current baseline port mapping data used as inputs described herein.

After the current baseline port mapping data has been identified, the AI productivity tool subagent 266 may use the diagnostic port data describing which of the ports 268, 270 are damaged to update the baseline port mapping data as input into a baseline mapping-to-text ML model algorithm 269. Invocation of computer-readable program code instructions for the baseline mapping-to-text ML model algorithm 269 with the diagnostic port data and updated baseline port mapping data as input provides, as output, generated user-guided text, audio or images describing which port to use in lieu of the port 268, 270 that is damaged. This generated user-guided text, audio, or images may be presented to the user at a video/graphics display device 250 or may even be presented via audio output at a speaker that directs the user to use the other working port 268, 270. In an embodiment, the recommendation and guidance graphical user interface (GUI) 271 that presents the user-guided text, audio, or images may be presented on a built-in video/graphics display device as shown in FIG. 2. In an embodiment, the recommendation and guidance GUI 271 with the user-guided text, audio, or images describes where the other working port 268, 270 (e.g., the second port 270) is located on the information handling system 200. This guidance will allow the user to make immediate use of the peripheral device or other hardware device being operatively coupled to the information handling system 200. In other embodiments, a further solution regarding how to deal with the damaged port 268, 270 may be generated as additional responsive capabilities to a user query input or to periodic port diagnostic detection.

As such, during operation, the hardware processor 202 or other hardware processing device (e.g., 204, 206, 208, 210) may execute the computer-readable program code instructions of a purchase recommendation module 296 to generate a recommendation purchase order in response to a user query input, to diagnostic port data, or both based on the current baseline port mapping data and hardware telemetry data to that identifies purchasable hardware. Identification of purchasable hardware may be identified via semantic correlation or other correlation from the current baseline port mapping data and hardware telemetry data, and is hardware that can be used as a substitute to the first port that is damaged. For example, the information handling system 200 may have had a first port 268 and a second port 270 used by the user to operatively couple or to typically couple two different peripheral devices, power, or other hardware devices to the information handling system 200 as determined from hardware data from the hardware telemetry gathering system 298. With, for example, the first port 268 being found to be damaged and the user being made aware of the damaged first port 268, the functionality of the peripheral device or other hardware device operatively coupled to the information handling system 200 at the first port 268 is now lost or at least impeded. In order to provide options, the recommendation purchase order generated by the purchase recommendation module 296 may receive as input the current baseline port mapping data and hardware telemetry for the ports 268, 270 as well as for other hardware components of the information handling system 200 and correlate to text descriptions of various additional hardware options that may supplement or replace the damaged first port 268. For example, the purchase order may reflect output of statistical correlation of the status of ports 268, 270 and other hardware components to match and generate a recommendation purchase order to purchase a docking station if the age of the information handling system 200 and/or hardware components are detected as sufficiently operational. The recommended docking station would include not only another port to replace the damaged first port 268, but also additional ports as well as a variety of different ports that may be used to operatively couple the peripheral device or other hardware device to the information handling system 200. Because the baseline port mapping data used by the purchase recommendation module 296 is specific to the user’s information handling system 200, the selection and recommendation of such a docking station will be customized to the current hardware within the information handling system 200 thereby directing the user to specific docking stations that will fulfill the user’s needs and act as a substitute for the damaged first port 268 as well as providing increased functionality.

In some embodiments, the purchase recommendation module 296, based on the baseline port mapping data and hardware telemetry for the ports 268, 270 as well as for other hardware components of the information handling system 200 received, may be matched via execution of an LLM algorithm to generating a recommendation purchase order with options besides suggesting the purchase of a docking station. For example, the baseline port mapping data and hardware telemetry for the ports 268, 270 as well as for other hardware components of the information handling system 200 may indicate that the information handling system 200 itself has reached a level of obsolescence or other hardware components are not operating efficiently such that the purchase of a new information handling system 200 with up-to-date technology should be contemplated by the user. Thus, the recommendation purchase order generated by the purchase recommendation module 296 may present more than relatively immediate solutions to the current problem of the defective first port 268. The purchase recommendation module 296 may also provide relatively more long-term solutions such as generating a recommendation purchase order for purchase of a new information handling system 200 as well. This provides a recommendation purchase order that can be presented to the user (e.g., via the video/graphics display device 250) that provides an array of options that can specifically address the issues encountered by the damaged first port 268 as well as state of other hardware components and user current or typical use of the ports 268, 270. A user can easily select, via the recommendation and guidance GUI 271, a described purchase option. Indeed, because the baseline port mapping data includes data specifying which peripheral devices are often used and operatively coupled to the information handling system 200, this customization of the generated recommendation purchase order also uses input of both those current needs as well as potential needs of the future by the user such as if and when additional peripheral devices such as another external video/graphics display device 250 may be coupled by a user to the information handling system 200.

In an embodiment, the baseline port mapping data may also include and be updated with user productivity metrics from hardware telemetry data of the hardware telemetry gathering system 298 that describe, in an embodiment, any or all reductions in user productivity resulting from the detection of non-use of the damaged first port 268. These metrics may include, for example, the lack of a previous peripheral device being currently operatively coupled to the information handling system 200 relative to typical operative coupling of peripheral devices to ports 268, 270, a reduction in hardware processing metrics from hardware telemetry indicative of lower user productivity, disablement or non-use of certain software applications from the hardware telemetry gathering system 298 that require specific peripheral devices to be present (e.g., a stylus not being used for a drawing software application), and the like. This user productivity metrics data may further inform as input to the purchase recommendation module 296 for the purchase recommendation module 296 to generate and provides a recommendation purchase order to the user that addresses the unavailability of the damaged first port 268.

In an embodiment, the generated recommendation purchase order from the purchase recommendation module 296 may also be transmitted to an ITDM operating an ITDM dashboard 297. The ITDM may be notified so that the user of the information handling system 200 may receive further IT support from the ITDM in deciding whether to purchase additional hardware, which additional hardware to purchase, and whether a new information handling system 200 should be ordered for the user. Because the ITDM, in some cases, may serve as the purchasing agent for the user or a plurality of users within an enterprise, the ITDM may simply review the issues resulting from the damaged first port 268, review the suggested recommendations presented on the purchase order, and purchase additional hardware on behalf of the user.

The systems and methods described herein, therefore, provide port resiliency for an information handling system 200. The systems and methods described herein further assists ITDMs or users in making purchasing decisions related to the issues associated with the damaged first port 268 thereby increasing user satisfaction and user productivity. Although some recommendations in the recommendation purchase order as well as the recommendations generated by the port identification and guidance module 292 guiding the user to use a different port (e.g., second port 270) may temporarily solve the issues with the damaged first port 268, user productivity may still be maintained at a certain level until more substantial or permanent solutions are sought after by the user and/or ITDM. This allows for flexibility and customization of the user’s unique issues such that the best temporary and permanent solutions are presented as options to the user. Additionally, the generated recommendation purchase order may further provide information to the user or ITDM that would not have been otherwise easily identified as valid options without diagnostic assessment by an ITDM of a peripheral device, hardware drivers, other hardware devices, or software thereby simplifying access to the number of possible solutions for the user and/or ITDM.

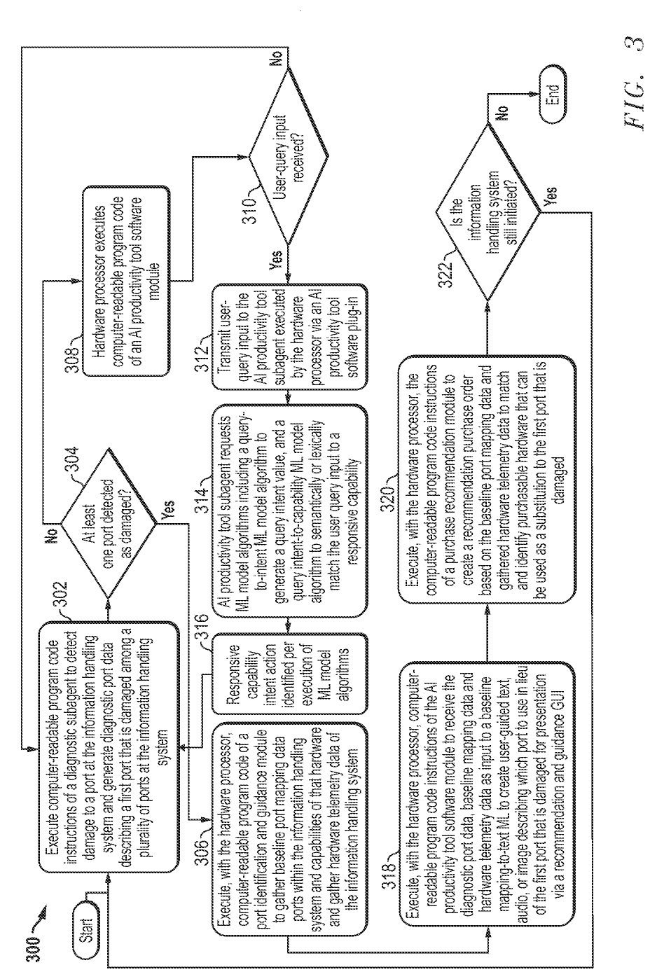

FIG. 3 is a flow diagram showing a method of executing computer-readable program code instructions of a port identification and guidance module for providing port resiliency and AI recommendations for failed ports at the information handling system according to an embodiment of the present disclosure. The method 300 described in connection with FIG. 3 may be operated on an information handling system such as an information handling system (e.g., 100, 200) described in connection with FIGS. 1 or 2. In an embodiment, the systems and methods described herein may operate on the information handling system such that the method is executed “on-the-box” such that a wired or wireless network connection to a network is not necessary for operation of the method. In another embodiment, some modules, databases, and/or processing resources may be maintained on a remote server and a wired or wireless network connection can be made with these remote servers and the method may be implemented as described herein.

The method 300 includes, at block 302, a hardware processor of the information handling system executing computer-readable program code instructions of a diagnostic subagent to detect damage to a port at the information handling system and generate diagnostic port data describing a first port that is damaged among a plurality of ports at the information handling system. Execution of the computer-readable program code instructions of a diagnostic subagent causes the information handling system to detect damage to, for example, a first port or second port at the information handling system as well as any other ports present at the information handling system. The execution of the computer-readable program code instructions of a diagnostic subagent may also generate diagnostic port data describing that, in the present example, at least one port (e.g., the first port) is damaged while the other ports (e.g., second port) remains operable at the information handling system.

In an example embodiment, the execution of the computer-readable program code instructions of a diagnostic subagent may identify a damaged port by accessing a hardware driver such those USB-C port hardware drivers associated with the USB-C ports, or other port hardware drivers for other port types, which includes the first port. Access to these port hardware drivers may allow the diagnostic subagent to request that an internal loopback test be conducted. As described herein, this internal loopback test may include sending specific test patterns or packets through the first port with the first port hardware drivers “listening” to receive the same data that was transmitted, checking for any errors in transmission, timing, or signal integrity. Additionally, the execution of the computer-readable program code instructions of the diagnostic subagent may interface with a PMU to test for power transmission at a power pin of the individual ports. Where any errors are detected in this process, the diagnostic subagent may return diagnostic port data indicating port failure and identification of which port is defective to a port identification and guidance module for processing described herein.

In an embodiment, the diagnostic subagent may conduct scheduled internal loopback test with the internal loopback tests or other tests periodically describing the operational state (e.g., damaged or operational) of each of the available ports such as the first port and second port. In another embodiment, the diagnostic subagent may set a process by which each hardware driver associated with each of the first port and second port may conduct this internal loopback test or other tests in every instance of a peripheral device being operatively coupled to the port. For example, when the user returns home and operatively couples the external video/graphics display device to the information handling system via the first port this action may trigger the USB-C port hardware driver associated with the first port to run this internal loopback test or other tests. This process may be conducted by each respective USB-C port hardware driver associated with each port such that the diagnostic subagent is informed if and when any of the ports have been found to be damaged. In yet other embodiments, the diagnostic subagent testing may occur as a responsive capability to a received user-query input at an AI productivity tool inquiring about a faulty peripheral device or even the port itself.

Thus, at block 304, the method 300 also include determining if at least one port has been identified as damaged. Where at least one port is detected as being damaged, the method 300 may continue to block 306 as described herein. This may include, as described herein, the information handling system gathering baseline port mapping data, diagnostic port data, and hardware telemetry data for later use in the method 300.

Where no ports have been detected as being damaged, the method 300 may continue to block 308 with the hardware processor of the information handling system executing computer-readable program code of an AI productivity tool software module as described herein. As described herein, user-query input may be used to prompt the diagnostic subagent to run the internal loopback test or any other test to determine the operability of the first port, the second port, or any other port. Thus, although the diagnostic subagent was run at block 302 and found no damaged ports, the user may nonetheless detect issues with the operation of one or more peripheral devices or other hardware devices operatively coupled to one or both of the first port and second port. For example, a user may operatively couple the external video/graphics display device to the information handling system by connecting a power/data cable to the first port (e.g., USB-C ports) once the user returns to the home office according to the example described herein. If the first port is damaged due to the repetitive insertion of the power/data cable into the first port, the user may detect this by seeing problems or distortions in the images and video presented on the external video/graphics display device.

The detection of problems or distortions in the images and video presented on the external video/graphics display device may prompt the user to interface with the AI productivity tool software module. As described herein, the user may provide user-query input requesting an explanation and/or solution to fix the perceived visual issues associated with the images and video presented on the external video/graphics display device. Thus, at block 310, the method 300 includes determining is user-query input has been received. Where user-query input is not received, the method returns to block 302 for processing as described herein.

Where, however, user-query input is determined to have been received at block 310, the method 300 continues to block 312. As described in embodiments herein, the information handling system includes an AI productivity tool software modules and an AI productivity tool software plug-in to receive user-query input and provide that user-query input to the AI productivity tool subagent. In some example embodiments presented herein, this user-query input may include audio recorded at the microphone of the user saying “please fix the issues with my screen blinking” where the user is detecting a blinking distortion in the image/video presented on the external video/graphics display device. In the embodiments herein, the user-query input may include audio input received from, for example, the microphone, text input by the user by the keyboard, or other forms of user-query input using any type of peripheral device. In an embodiment, the execution of the computer-readable program code instructions of the AI productivity tool subagent by the hardware processor or any other hardware processing device selects among a plurality of available ML module algorithms maintained within a ML model algorithm database for use with execution of the plurality of AI productivity tool software module.

In order to accomplish this, the method 300 includes transmitting the user-query input to the AI productivity tool subagent executed by a hardware processor via the AI productivity tool plug-in.

At block 314, the method 300 also includes the AI productivity tool software module invoking one or more available ML module algorithms thereby allowing the processes of the AI productivity tool software module to identify responsive capabilities from among their respective sets of available capabilities and respond to received user query inputs according to methods described herein. In an embodiment, the execution of the computer-readable program code instructions of the AI productivity tool subagent may call an SDK module. The SDK module may include any computer-readable program code instructions that is executed by the hardware processor or other hardware processing resource to request that a ML module algorithms that may be invoked to support the identification of, in an embodiment, one or more capability intent action based on received user-query inputs from a user at the AI productivity tool software module. Additionally, the selected ML module algorithms for a similar or common identified AI productivity-tool operation type may satisfy an interface contract requested by the AI productivity tool subagent such that the query intent value from the user-query inputs may be interpreted and an available capability associated with one of the plurality of AI productivity tool-enablable software applications as the capability intent action can be matched to the user’s query input. The interface contract described herein defines the requirements that selected ML module algorithms are to have in order to be able receive a specific type of input from the AI productivity tool software module, the AI productivity tool subagent, or any AI productivity tool-enablable software application and to provide a specific type of output to the AI productivity tool subagent, the AI productivity tool software module, and/or AI productivity tool-enablable software applications. In an embodiment, the interface contract is generated by an AI productivity proxy API invoked by the SDK module in order to identify the similar or common productivity-tool operation type ML module algorithms that provides the appropriate output to the AI productivity tool subagent.

In example embodiments herein, the ML module algorithms may include a query input-to-intent ML model algorithm that receives the user-query input (e.g., “please fix the issues with my screen blinking”), and with an embedding algorithm generates a vectorized query intent value for the user-query input for later correlation with a capability intent value. In embodiments where the user-query input is in audio form, the AI productivity tool subagent may invoke the execution of a speech-to-text ML model algorithm to initially convert this audio into text for use with the query input-to-intent ML model algorithm to generate the vectorized query intent value for the user-query input for later correlation with a capability intent value as described herein. In an example embodiment, the ML module algorithms may also include a query intent-to-capability matching ML model algorithm. The query intent-to-capability matching ML model algorithm receives the vectorized query intent value from the execution of the query input-to-intent ML model algorithm as input and then matches the vectorized query intent value to a vectorized capability intent value associated with the AI productivity tool-enablable software application via a similarity correlation algorithm for lexical or semantic matching to identify a responsive capability, at block 316, that can serve as the capability intent action responsive to a user-query input. For example, the query intent-to-capability module may execute a cosine similarity matching algorithm between query intent values and available capability intent values in some embodiments.

At block 316, the best matched responsive capabilities may be identified. In an example embodiment, a capability or plurality of capabilities having the highest similarity scores may be selected and executed as described herein. In another embodiment, a capability or plurality of capabilities having a score above a threshold score may be selected and executed as described herein. Thus, a diagnostic capability associated with the diagnostic subagent may be identified as a capability, among a plurality of identified capabilities, with the diagnostic capability directing the initiation of an internal loopback test or other diagnostic port testing to test the operability of the first port, second port, or any other port of the information handling system. Thus, where a capability such as the diagnostic capability is identified at block 316, the method 300 proceeds to block 302 with the computer-readable program code instructions of the diagnostic subagent being executed to determine, at block 304, if at least one port is damaged. Where a port (e.g., a first port) is determined to be damaged, the process continues to block 306 described herein. Otherwise, the system may continue to monitor for detected port failure or for new user query inputs until shutdown.

At block 306, the method 300 further includes the hardware processor executing computer-readable program code instructions of a port identification and guidance module to gather baseline port mapping data describing mapping of hardware including the ports within the information handling system, capabilities of that hardware, and usage such as with peripheral devices at or typically at the ports. Thus, when the diagnostic subagent causes the internal loopback test to be conducted in response to a periodic scheduling of the test or in response to the user-query input, the detection of a damaged port causes a number of responsive capability operations to be executed by a ML model algorithm of the AI productivity tool to identify the damaged port to the user, direct the user to other ports that can be used to operatively couple peripheral devices, power, or other hardware devices to the information handling system, and generate or create a recommendation purchase order providing details related to what hardware devices the user could purchase to supplement or replace the detected damaged port. In an embodiment, the hardware processor or other hardware processing device may execute computer-readable program code of the port identification and guidance module to gather baseline port mapping data that identifies one or more locations of ports or other hardware within the information handling system and capabilities or status of that hardware. In an embodiment, the port identification and guidance module may access a remote baseline hardware mapping database at the remote management server that maintains this baseline port mapping data identifying “as-built” location in the information handling system and capabilities. The remote baseline hardware mapping database may be maintained by a manufacturer of the information handling system and may include purchasing data describing the information handling system type, model, or custom specification purchased by the user along with all hardware, firmware, and software components originally in the information handling system as baseline golden configuration. Additionally, or alternatively, the remote baseline port mapping data may be retrieved, updated, and maintained on a built-in baseline hardware mapping database maintained on-the-box at the information handling system. This updated or current baseline port mapping may be generated via periodic execution of a capability associated with any AI productivity tool-enablable software applications and from detected hardware telemetry data for peripheral devices attached or typically attached to ports as well as telemetry for other hardware components and software as well as with diagnostic port data described herein.

After the baseline port mapping data, as well as diagnostic port data, and hardware telemetry data has been identified, the method 300 continues to block 318 to execute, with the hardware processor, computer-readable program code instructions of the AI productivity tool software module to receive the diagnostic port data, baseline port mapping data, and computer-readable program code instructions and provide, as input, the diagnostic port data, baseline port mapping data, and hardware telemetry data to a baseline mapping-to-text ML. The hardware processor executes computer-readable program code instructions of the baseline mapping-to-text ML model algorithm or other LLM algorithm for the port identification and guidance model using the AI productivity tool software module to generate output user-guided text, audio, or images describing which port to use in lieu of the first port that is damaged. In an embodiment, the AI productivity tool subagent may use the diagnostic port data describing which of the ports are damaged and what, if any, capabilities remain (e.g., power or data), and the baseline port mapping data as input into a baseline mapping-to-text ML model algorithm. Invocation of the baseline mapping-to-text ML model algorithm with the diagnostic port data, baseline port mapping data, and hardware telemetry data as input provides, as output, user-guided text, audio, or images describing other unaffected ports and their location on the information handling system to use in lieu of the port that is damaged. Further, the damaged port may be identified as having remaining capabilities, such as power but not data, or vice-versa, and may be part of the user guided text, audio, or images as well in some embodiments. Additionally, hardware telemetry data used as input to the mapping-to-text ML model algorithm may identify what peripheral devices are or will typically be coupled to the ports in the user-guided text, audio, or image.

This user-guided text, audio, or images may be presented to the user at a video/graphics display device or may even be presented via audio output at a speaker that directs the user to use the other working port or ports or how to reconfigure peripheral devices or power based on remaining capabilities of a damaged port and other available working ports. In an embodiment, a recommendation and guidance GUI presents the user-guided text or images on a built-in video/graphics display device or user guided audio may be played via a speaker. In an embodiment, the recommendation and guidance GUI with the user-guided text or images describes where the other working port is located on the information handling system. This guidance will allow the user to make immediate use of the peripheral device or other hardware device being operatively coupled to the information handling system while a solution regarding how to deal with the damaged port is being generated.

The method 300 further includes, at block 320, executing, with the hardware processor, the computer-readable program code instructions of a purchase recommendation module to generate a recommendation purchase order based input of the baseline port mapping data and hardware telemetry data to correlate with purchasable hardware that can be used as a substitute or replacement to the first port that is damaged. For example, the information handling system may have had a first port and a second port typically used by the user to operatively couple two different peripheral devices or other hardware devices to the information handling system from user productivity metrics in the hardware telemetry data. With, for example, the first port being found to be damaged and the user being made aware of the damaged first port, the functionality of the peripheral device or other hardware device operatively coupled to the information handling system at the first port is now lost or impeded. In order to provide options, the recommendation purchase order generated by the purchase recommendation module may receive as input the baseline port mapping data and hardware telemetry data received at the port identification and guidance module and, with a semantic or lexical match or via an LLM algorithm, correlate that input data with various additional hardware options that may replace or substitute the damaged first port. The identified purchasable hardware substitute options may then be inserted within a purchase order template to generate a recommendation purchase order in some embodiments. For example, the recommendation purchase order may include recommendations to purchase a docking station when other hardware components operate sufficiently that would include not only another port to replace the damaged first port but also additional ports as well as a variety of different ports that may be used to operatively couple the peripheral devices or other hardware devices typically coupled by the user to the information handling system. Because the baseline port mapping data used by the purchase recommendation module is specific to the user’s information handling system, the selection and recommendation of such a docking station will also be customized to the current hardware within the information handling system thereby directing the user to specific docking stations that are supported and will fulfill the user’s needs and act as a substitute for the damaged first port as well as providing increased functionality.

In some embodiments, the purchase recommendation module, based on the baseline port mapping data received, may be matched via an LLM with generating a recommendation purchase order having other options besides suggesting the purchase of a docking station. For example, the baseline port mapping data may indicate that the information handling system itself has reached a level of obsolescence or other hardware components are failing such that the purchase of a new information handling system with up-to-date technology should be contemplated by the user. Thus, the recommendation purchase order generated by the purchase recommendation module may present more than a relatively immediate solution to the current problem of the defective first port, but generate a recommendation purchase order that may also provide relatively more long-term solutions such as the purchase of docking station, a new information handling system, or other components as well. This provides a generated recommendation purchase order that can be presented to the user that provides an array of options that can specifically address the issues encountered by the damaged first port and easily selected in the recommendation and guidance GUI to execute purchase of an option. Indeed, because the baseline port mapping data includes data specifying which peripheral devices are often used and operatively coupled to the information handling system, this customization of the generated recommendation purchase order also uses input of both those current needs as well as potential needs of the future by the user such as if and when additional peripheral devices such as another external video/graphics display device may be coupled by a user to the information handling system.

In an embodiment, the baseline port mapping data may also include and be updated with user productivity metrics form the hardware telemetry data from execution of a hardware telemetry gathering module that describe, in an embodiment, any or all reductions in user productivity resulting from the detection of non-use of the damaged first port. These metrics may include, for example, the lack of a previous peripheral device being operatively coupled to the information handling system relative to typical operative coupling of peripheral device to ports of the information handling system, a reduction in hardware processing metrics indicative of lower user productivity from the hardware telemetry data, disablement or non-use of certain software applications from the hardware telemetry data that require specific peripheral devices to be present (e.g., a stylus not being used for a drawing software application), and the like. This user productivity metrics data may further be used as input to the purchase recommendation module as the purchase recommendation module generates a recommendation purchase order to the user that addresses the unavailability of the damaged first port.

In an embodiment, the generated recommendation purchase order from the purchase recommendation module may also be transmitted to an ITDM operating an ITDM dashboard. The ITDM may be notified so that the user of the information handling system may receive further IT support from the ITDM in deciding whether to purchase additional hardware, which additional hardware to purchase, and whether a new information handling system should be ordered for the user. Because the ITDM, in some cases, may serve as the purchasing agent for the user or a plurality of users within an enterprise, the ITDM may simply review the issues resulting from the damaged first port, review the suggested recommendations presented on the purchase order, and purchase additional hardware on behalf of the user.

The systems and methods described herein, therefore, provide port resiliency for an information handling system. The systems and methods described herein further assist ITDMs or users in making purchasing decisions related to the issues associated with the damaged first port thereby increasing user satisfaction and user productivity. Although some recommendations in the recommendation purchase order as well as the recommendations generated by the port identification and guidance module guiding the user to use a different port may temporarily solve the issues with the damaged first port, user productivity may still be maintained at a certain level until more substantial or permanent solutions are sought after by the user and/or ITDM. This allows for flexibility and customization of the user’s unique issues such that the best temporary and permanent solutions are presented as options to the user. Additionally, the generated recommendation purchase order may further provide information to the user or ITDM that would not have been otherwise easily identified as valid options without diagnostic assessment of the peripheral device, other hardware components, hardware drivers, or software since port failure may not be obvious but may be common. Thus, a number of possible solutions to the detection of a failed port for the user and/or ITDM may be easily accessible.

At block 322, the method 300 includes determining if the information handling system is still initiated. Where the information handling system is still initiated, the method 300 proceeds to block 302 as described herein. Where the information handling system is no longer initiated, the method 300 may end here.

The blocks of the flow diagrams of FIG. 3 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system executing computer-readable program code instructions to provide port resiliency and artificial intelligence (AI) recommendations for damaged ports at the information handling system comprising:
a hardware processor, a data storage device, and a power management unit (PMU) to provide power to the hardware processor and data storage device;
the hardware processor to execute computer-readable program code instructions of a diagnostic subagent to detect damage to a first port at the information handling system via port testing and generate diagnostic port data describing the first port that is damaged among a plurality of ports at the information handling system;
the hardware processor to execute computer-readable program code of a port identification and guidance module to gather baseline port mapping data describing mapping of hardware components including the first port and at least a second port within the information handling system and capabilities of those hardware components and the plurality of ports; and
the hardware processor to execute computer-readable program code instructions of the port identification and guidance module to receive and input the diagnostic port data and baseline port mapping data to a baseline mapping-to-text machine learning (ML) algorithm to generate user-guided text , audio, or image describing which port to use in lieu of the first port that is damaged.

2. The information handling system of claim 1 further comprising:
the hardware processor to execute the computer-readable program code instructions of an artificial intelligence (AI) productivity tool software module to receive user-query input associated with operation of a peripheral device operationally coupled to the first port that is damaged, and invoke a plurality of ML model algorithms to identify a plurality of responsive capabilities associated with the diagnostic subagent and the port identification and guidance module that semantically or lexically match as responsive to the user-query input.

3. The information handling system of claim 2, wherein a responsive capability identified by the AI productivity tool software module includes executing an internal loopback testing capability associated with a port driver of the ports by the diagnostic subagent.

4. The information handling system of claim 1 further comprising:
the hardware processor to execute the computer-readable program code instructions of the diagnostic subagent to detect damage to a port at the information handling system via an internal loopback test via execution of port drivers for the plurality of ports at the information handling system.

5. The information handling system of claim 1 further comprising:
the hardware processor to execute the computer-readable program code of the port identification and guidance module to gather baseline port mapping data of an as-built configuration from a remote management server for a type and specified customization of the information handling system as purchased.

6. The information handling system of claim 1 further comprising:
the hardware processor to execute computer-readable program code instructions of a purchase recommendation module to generate a recommendation purchase order based on the baseline port mapping data, the diagnostic port data, and gathered hardware telemetry data on other hardware components in the information handling system to lexically or semantically match and identify purchasable hardware that can be used as a substitute to the first port that is damaged.

7. The information handling system of claim 6 further comprising:
the hardware processor to execute the computer-readable program code instructions of the purchase recommendation module to indicate the identified purchasable hardware is a docking station comprising additional ports as the substitute to the first port that is damaged.

8. The information handling system of claim 1, wherein the first port that is damaged is a USB-C port.

9. A method executing computer-readable program code instructions for providing port resiliency and artificial intelligence (AI) recommendations for damaged ports at an information handling system comprising:
executing, with a hardware processor, computer-readable program code instructions of a diagnostic subagent to detect damage, via port testing, to a first port at the information handling system and generate diagnostic port data describing the first port that is damaged among a plurality of ports at the information handling system;
executing, with the hardware processor, computer-readable program code of a port identification and guidance module to gather baseline port mapping data describing mapping of hardware components including locations of the plurality of ports within the information handling system and capabilities of those hardware components and the plurality of ports;
executing, with the hardware processor, computer-readable program code instructions of the port identification and guidance module to receive and input the diagnostic port data, baseline port mapping data, and hardware telemetry data for peripheral devices historically coupled to the plurality of ports, and executing a baseline mapping-to-text machine learning (ML) algorithm to generate user-guided text, audio, or image describing which port to use in lieu of the first port that is damaged; and
executing, with the hardware processor, computer-readable program code instructions to display the user-guided text or image via a recommendation and guidance graphical user interface (GUI) on a display device or play user-guided audio via a speaker.

10. The method of claim 9 further comprising:
executing, with the hardware processor, the computer-readable program code instructions of an artificial intelligence (AI_ productivity tool software module to receive a user-query input associated with operation of a peripheral device operatively coupled to the first port that is damaged and invoke a plurality of ML model algorithms to identify a plurality of responsive capabilities that semantically or lexically match as responsive to the user-query input that are associated with the diagnostic subagent and the port identification and guidance module.

11. The method of claim 10, wherein a responsive capability identified by the AI productivity tool software module includes the port testing via a port driver as the responsive capability associated with the diagnostic sub-agent.

12. The method of claim 9 further comprising:
executing, with the hardware processor, the computer-readable program code instructions of the diagnostic subagent to detect damage to the first port at the information handling system via port testing that includes an internal loopback test via execution of a port driver and power test via a power management unit.

13. The method of claim 9 further comprising:
executing, with the hardware processor, the computer-readable program code of the port identification and guidance module to gather baseline port mapping data from a remote management server via a wireless interface adapter operatively coupled to a network.

14. The method of claim 9 further comprising:
executing, with the hardware processor, the computer-readable program code of a purchase recommendation module to generate a recommendation purchase order based on the baseline port mapping data and the hardware telemetry data for hardware component functions to match and identify purchasable hardware that can be used as a substitute to the first port that is damaged, wherein the purchasable hardware is a docking station comprising additional ports as the substitute to the first port that is damaged when other hardware components are operating according to specification in the hardware telemetry data.

15. The method of claim 14 further comprising:
executing, with the hardware processor, the computer-readable program code instructions of the purchase recommendation module to transmit to an internet technology decision maker (ITDM) operating an ITDM dashboard at a remote management server the recommendation purchase order with the identified purchasable hardware via a communication on an operatively coupled network.

16. The method of claim 9, wherein the first port that is damaged is a USB-C port.

17. An information handling system comprising:
a hardware processor, a data storage device, and a power management unit (PMU) to provide power to the hardware processor and data storage device;
the hardware processor to execute computer-readable program code instructions of a diagnostic subagent to detect damage to a first port at the information handling system via port testing and generate diagnostic port data describing the first port that is damaged among a plurality of ports at the information handling system;
the hardware processor to execute computer-readable program code of a port identification and guidance module to gather baseline port mapping data describing mapping of hardware components including locations of the plurality of ports within the information handling system and capabilities of those hardware components and the plurality of ports;
the hardware processor to execute computer-readable program code instructions of the port identification and guidance module to receive and input the diagnostic port data, the baseline port mapping data, and hardware telemetry data for the hardware components and the plurality of ports into a baseline mapping-to-text machine learning (ML) algorithm to generate user-guided text or audio describing which port to use in lieu of the first port that is damaged; and
the hardware processor to execute computer-readable program code instructions of a purchase recommendation module to generate a recommendation purchase order based on the baseline port mapping data, and the hardware telemetry data to match and identify purchasable hardware that can be used as a substitute to the first port that is damaged.

18. The information handling system of claim 17 further comprising:
the hardware processor to execute the computer-readable program code instructions of an artificial intelligence (AI) productivity tool software module to receive user-query input associated with operation of a peripheral device operatively coupled to the first port that is damaged and invoke a plurality of ML model algorithms to identify a plurality of responsive capabilities associated with the diagnostic subagent, the port identification and guidance module executing the baseline mapping-to-text ML algorithm, and the purchase recommendation module that semantically or lexically match as responsive to the user-query input.

19. The information handling system of claim 17 further comprising:
the hardware processor to execute the computer-readable program code instructions of the diagnostic subagent to detect the damage to the first port at the information handling system with an internal loopback test via execution of a port driver and a power test via a power management unit.

20. The information handling system of claim 17 further comprising:
the hardware processor to execute computer-readable program code instructions of the purchase recommendation module to transmit the recommendation purchase order to an internet technology decision maker (ITDM) operating an ITDM dashboard at a remote management server operatively coupled network.
